(19) United States
(12) Patent Application Publication
(10) Pub. No.: US 2006/0261816 A1
(43) Pub. Date: Nov. 23, 2006

(54) Method of diagnosis of a state of end of life of a determined type of battery

(76) Inventors: Jacques Rocher, Saint-Orens (FR); Frederic Stuyk, Toulouse (FR)

Correspondence Address: YOUNG & THOMPSON, 745 SOUTH 23RD STREET, 2ND FLOOR, ARLINGTON, VA, 22202, US

(21) Appl. No.: 11/436,642

(22) Filed: May 19, 2006

(30) Foreign Application Priority Data
May 20, 2005 (FR) 0505069

(51) Int. Cl. G01N 27/416

(52) U.S. Cl. 324/433

(57) ABSTRACT

The invention relates to a method of diagnosis of a state of end of life of a determined type of battery such as a cell, in particular a lithium/manganese cell. According to this method, during the use of a battery of the determined type within the framework of a given application, periodic measurements are performed of the voltage across the terminals of the battery and of the corresponding ambient temperature, each measured value of the voltage across the terminals of the battery is compared with corresponding values previously stored during a specific preliminary calibration phase, a counting is established of the number of measured values below the corresponding values measured, and an alert signal warning that the end of the life of the battery is delivered after counting of a number n of measured values below the corresponding values stored.

The invention relates to a method of diagnosis of a state of end of life of a determined type of battery such as a cell, in particular a lithium/manganese cell, exhibiting specific operating characteristics, within the framework of a given application of use of said battery.

This invention applies in particular, but not exclusively, within the automobile sector, to the diagnosis of a state of end of life of cells, in particular lithium/manganese cells, integrated into electronic packages, such as for example the electronic packages adapted to be mounted on the wheels of vehicles with a view to the measurement and the transmission to a central unit mounted on said vehicles of operating parameters of said wheels.

Featuring among the operating characteristics that batteries such as cells have to meet, are in particular the guaranteeing of a minimum lifetime of said batteries under predetermined normal operating conditions, including the provision, during the whole of this lifetime, of a voltage greater than a predetermined threshold across the terminals of these batteries.

Thus, in particular, in the automobile sector, the cells integrated into electronic packages must exhibit operating characteristics and capacity making it possible to guarantee an adequate power supply for the various components of these electronic packages during their entire lifetime fixed by the automobile manufacturer.

However, in practice, the lifetime of the batteries and the maximum voltage that can be provided across the terminals of the batteries depend directly on the operating parameters of the intended application, such as the ambient temperature of the medium in which these batteries are found, the consumptions of current per unit time, the forms of the current consumed, etc.

Therefore, the lifetime of batteries of the same type may vary appreciably as a function of the operating parameters of the applications of use of said batteries.

This lifetime conditioning correct operation of the intended applications, it may be useful, if not necessary, to furnish said applications with telltale facilities designed to make it possible to diagnose a state of end of life of said batteries.

The invention is aimed at achieving this objective and its essential objective is therefore to provide a method making it possible to diagnose a state of end of life of a determined type of battery such as a cell.

Another objective of the invention is to provide a method of diagnosis which, applied to the electronic packages adapted to be mounted on the wheels of vehicles, requires only a software adaptation of said packages.

For this purpose, the invention is aimed at a method of diagnosis according to which:
in a prior phase of calibration of the determined type of battery within the framework of the intended application:
   a mission profile is established, representative of the operating parameters of the intended application, and adapted for combining a profile of temperatures, a profile of consumptions of current per unit time, and a profile of forms of the current consumed,
   criteria of operating limit of the battery are selected on the basis of values of voltages across the terminals of said battery below which, for given ambient temperatures of the medium in which this battery is disposed, the latter should be regarded as at the end of its life,
   an accelerated ageing test of the application is performed, and during the course of this ageing test, values of the voltage across the terminals of the battery which are representative of the selected operating criteria of said battery are measured and stored,
and during the use of a battery of the determined type within the framework of the intended application:
   periodic measurements of the voltage across the terminals of the battery and of the corresponding ambient temperature are performed,
   each measured value of the voltage across the terminals of, the battery is compared with the corresponding stored values,
   a counting is established of the number of measured values that are below the corresponding values measured,
   and an alert signal warning of the end of the life of the battery is delivered after counting of a number n of measured values that are below the corresponding values stored, with n≧1.

The method according to the invention therefore consists, firstly:
in initially selecting criteria of operating limit of the battery that are suitable for making it possible to determine, through measurements of the voltage across the terminals of this battery, whether the latter is or is not suitable for guaranteeing the correct supply for the application,
and in performing an accelerated ageing test making it possible to store values representative of the operating limit criteria.

This method consists thereafter in using the values stored as reference values intended to be compared with results of periodic measurements, with a view to making it possible to detect, during the use of the battery, the moment at which the latter reaches a state of end of life.

This method therefore provides a software solution making it possible to diagnose a state of end of life of a determined type of battery such as a cell, this solution offering great flexibility of use related to freedom of choice on the one hand of various operating criteria, and on the other hand of diverse values of the number “n” of values counted.

Concerning the choice of the operating limit criteria, a first advantageous mode of implementation of the invention can thus consist in selecting and in storing a pair of values that is made up of the theoretical value of the minimum voltage across the terminals of said battery, the so-called minimum operating voltage, suitable for guaranteeing the operation of the application, with which is associated a predetermined threshold value of ambient operating temperature.

According to this advantageous mode of implementation, furthermore, during the use of a battery, and for each of the measurements performed:
the voltage measured is compared with the minimum operating voltage stored,
and when the measured voltage is below the minimum operating voltage stored, the counting is incremented if and only if the ambient temperature measured is below the threshold temperature stored.

Additionally, within the framework of this mode of implementation, and in an advantageous manner according to the invention, when the measured voltage is below the minimum operating voltage stored, the counting is incremented by assigning to this incrementation weighting coefficients of predetermined values such that said values increase with ambient temperature.

Concerning the choice of the operating limit criteria, a second advantageous mode of implementation of the invention may also consist in selecting a limit operating age.

In this case, when the accelerated ageing of the battery reaches the selected limit age, and for a predetermined span of ambient temperature values, a plurality of values of the voltage across the terminals of the battery each corresponding to a given ambient temperature is measured and stored.

Moreover, during the use of a battery, and for each of the measurements performed:
the voltage measured is compared with the voltage stored obtained for the same ambient temperature as that logged during the measurement,
and the counting is incremented when the voltage measured is below the voltage stored.

It should be noted that, according to the invention, the parameters measured consist of parameters usually measured during the operation of contemporary conventional electronic packages adapted to be mounted on the wheels of vehicles, so that the application of the invention to such packages requires only a simple software adaptation of them.

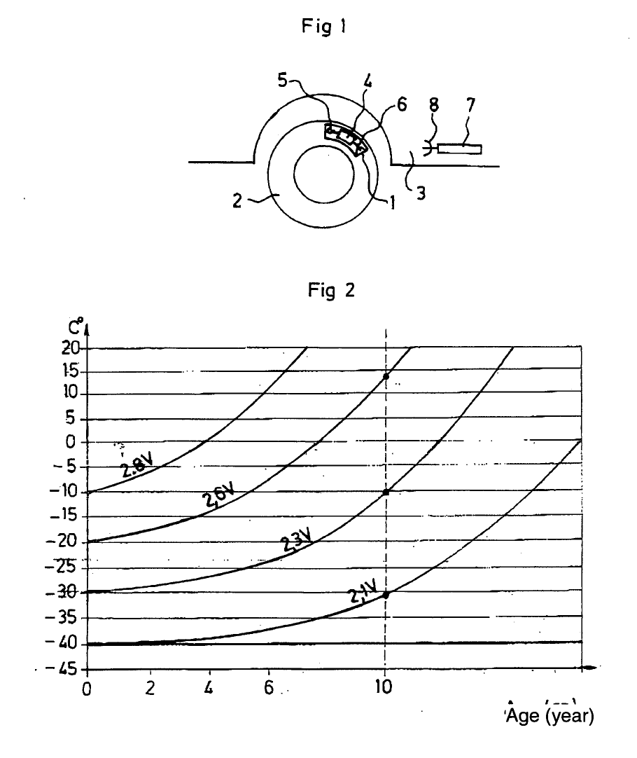

Other characteristics aims and advantages of the invention will emerge from the detailed description which follows with reference to the appended drawings which represent a non-limiting exemplary preferential embodiment thereof. In these drawings:
FIG. 1 is a partial and schematic lateral view of a vehicle equipped with a monitoring system in accordance with the invention,
and FIG. 2 is a chart representing a net of curves each representative of the time dependency of the minimum temperature for which a given value of voltage across the terminals of a cell of an electronic package of a monitoring system is obtained.

The monitoring system implementing the method of diagnosis according to the invention is represented, in FIG. 1, mounted on a vehicle 3 furnished with four wheels 2 each fitted conventionally with a tyre.

Such monitoring systems conventionally comprise, firstly, associated with each wheel 2, an electronic package such as 1, for example secured to the rim of said wheel in such a way as to be positioned inside the casing of the tyre.

Each of these electronic packages 1 integrates sensors dedicated to the measurement of parameters, such as pressure, temperature, acceleration, etc. connected to a microprocessor based calculation unit 4 supplied with power by means of a button-cell 5 such as a lithium/manganese cell, and linked to an RF transmitter connected to a low-frequency antenna 6.

The monitoring system also comprises a centralized computer or central unit 7 comprising a microprocessor and integrating an RF receiver able to receive the signals transmitted by each of the four electronic packages 1, and which is connected, for this purpose, to an antenna 8.

In a standard fashion, such a monitoring system and in particular its central unit 7 are designed in such a way as to inform the driver of any abnormal variation in the parameters measured by the sensors associated with the wheels 2.

According to the invention, the microprocessor based calculation unit 4 of each electronic package comprises:
means of storing values representative of criteria of operating limit of the cell 5, below which said cell is regarded as being in a state of end of life, that is to say regarded as unsuitable for affording an adequate supply for the application,
and a management unit linked to the storage means and to the measurement sensors, and programmed to detect, by comparison between the values measured and stored, a possible state of end of life of the cell 5, and to control the transmission of a corresponding warning signal.

The implementation of the method of diagnosis according to the invention requires the carrying out of a prior procedure for calibrating the determined type of cell 5 within the framework of the application intended, said calibration procedure consisting:
establishing a mission profile representative of the operating parameters of the intended application, designed to combine a profile of temperatures, a profile of consumptions of current per unit time, and a profile of forms of the current consumed,
and in performing an accelerated ageing test of the application, by measuring for example and by storing, during this ageing test, the time dependency of ambient temperatures for which predetermined given values of the voltage across the terminals of the cell 5 are obtained.

Such a calibration step leads to the obtaining of a chart such as that represented in FIG. 2, formed of a net of curves each representative of the time dependency of the temperature for which a given value of voltage across the terminals of the cell 5 is obtained.

On the basis of such a chart, a first exemplary implementation of the invention can consist in selecting, as criterion of operating limit of the cell 5, a limit operating age.

Within the framework of this example, the values stored representative of the operating criterion consist, for each curve of the net, of a pair of values consisting of the voltage across the terminals of the cell 5 and of the ambient temperature for which this voltage value is obtained.

According to this example, the verification of the state of the cell 5 consists, moreover, in comparing the voltage measured with the voltage stored obtained for one and the same ambient temperature as that logged during the measurement, and in incrementing a counter when the voltage measured is below the voltage stored.

By way of illustration of this example, and referring to FIG. 2, for a limit age equal to ten years, the values stored may in particular comprise the following pairs of values: (2.1 V, −30° C.), (2.3 V, −10° C.), and (2.6 V, 13° C.).

On the basis of the chart represented in FIG. 2, a second exemplary implementation of the invention may consist in selecting, as criterion of operating limit of the cell 5, a pair of values which is made up of the theoretical value of the minimum voltage across the terminals of said battery, the so-called minimum operating voltage, suitable for guaranteeing the operation of the application, with which is associated a predetermined threshold value of ambient operating temperature.

The minimum operating voltage is conventionally defined by providers of components integrated into electronic packages 1, and exhibits a mean value of the order of 2.1 volts within the framework of the present example.

The threshold value of the ambient temperature is for its part determined, as a function of the mean temperatures of the areas of deployment of the vehicles 3 intended to be equipped with the electronic packages 1. This value may conventionally be deduced from the analysis of the curve corresponding to the voltage equal to 2.1 volts, represented in FIG. 2.

According to this second example, the verification of the state of the cell 5 consists in comparing the voltage measured with the minimum operating voltage stored, and when this measured voltage is below said minimum operating voltage, in incrementing a counter if and only if the ambient temperature measured is below the threshold temperature stored.

Furthermore, in order to refine the incrementation and render the latter more realistic, the incrementation is advantageously weighted by means of weighting coefficients of the predetermined values such that said values increase with ambient temperature.

It should moreover be noted that only the data attached to the 2.1 volts curve are necessary for the implementation of this second example.

It should finally be noted that, according to the method of diagnosis of the invention, the only measurements performed periodically consist of measurements of temperatures and of voltages. However, these measurements are performed and used within the framework of the application for monitoring the operating parameters of the wheels 2, so that the implementation of the invention requires only a very simple software adaptation.

1. A method of diagnosis of a state of end of life of a determined type of battery (5) such as a cell, in particular a lithium/manganese cell, exhibiting specific operating characteristics, within the framework of a given application of use of said battery, characterized in that,
in a prior phase of calibration of the determined type of battery (5) within the framework of the intended application:
a mission profile is established, representative of the operating parameters of the intended application, and adapted for combining a profile of temperatures, a profile of consumptions of current per unit time, and a profile of forms of the current consumed,
criteria of operating limit of the battery (5) are selected on the basis of values of voltages across the terminals of said battery below which, for given ambient temperatures of the medium in which this battery is disposed, the latter should be regarded as at the end of its life,
an accelerated ageing test of the application is performed, and during the course of this ageing test, values of the voltage across the terminals of the battery (5) which are representative of the selected operating criteria of said battery are measured and stored,
and during the use of a battery (5) of the determined type within the framework of the intended application:
periodic measurements of the voltage across the terminals of the battery (5) and of the corresponding ambient temperature are performed,
each measured value of the voltage across the terminals of the battery (5) is compared with the corresponding stored values,
a counting is established of the number of measured values that are below the corresponding values measured,
and an alert signal warning of the end of the life of the battery (5) is delivered after counting of a number n of measured values that are below the corresponding values stored, with n≧1.

2. The method of diagnosis as claimed in claim 1, characterized in that:
a pair of values which is made up of the theoretical value of the minimum voltage across the terminals of said battery, the so-called minimum operating voltage, suitable for guaranteeing the operation of the application, is selected previously, as criteria of operating limit of the battery (5) and is stored, with which is associated a predetermined threshold value of ambient operating temperature,
and during the use of a battery (5), and for each of the measurements performed:
the voltage measured is compared with the minimum operating voltage stored,
and when the measured voltage is below the minimum operating voltage stored, the counting is incremented if and only if the ambient temperature measured is below the threshold temperature stored.

3. The method of diagnosis as claimed in claim 2, characterized in that, when the measured voltage is below the minimum operating voltage stored, the counting is incremented by assigning to this incrementation weighting coefficients of predetermined values such that said values increase with ambient temperature.

4. The method of diagnosis as claimed in claim 1, characterized in that:
a limit operating age is selected previously, as criterion of operating limit of the battery (5), and when the accelerated ageing of said battery reaches this limit age, and for a predetermined span of ambient temperature values, a plurality of values of the voltage across the terminals of the battery (5) each corresponding to a given ambient temperature is measured and stored,
and during the use of a battery (5), and for each of the measurements performed:
the voltage measured is compared with the voltage stored obtained for the same ambient temperature as that logged during the measurement,
and the counting is incremented when the voltage measured is below the voltage stored.
